(19) United States
(12) Patent Application Publication
(10) Pub. No.: US 2022/0385607 A1
(43) Pub. Date: Dec. 1, 2022

(54) DYNAMIC CONTROL OF ACCESS PERMISSIONS FOR SPLIT MESSAGE THREADS OF A COMMUNICATION SYSTEM

(71) Applicant: MICROSOFT TECHNOLOGY LICENSING, LLC, Redmond, WA (US)

(72) Inventor: Amer Aref HASSAN, Kirkland, WA (US)

(21) Appl. No.: 17/332,958

(22) Filed: May 27, 2021

(51) Int. Cl. H04L 12/58; G06F 3/0481

(52) U.S. Cl. CPC H04L 51/16; G06F 3/0481

(57) ABSTRACT

The techniques disclosed herein provide dynamic control of access permissions for message threads. A system stores a data structure that manages relationships between thread families and permissions for users for each thread. The system can update the permissions for select threads according to a policy as users are added or removed from other related threads. A parent thread having a first set of common participants can be split into multiple child threads, which can involve a split of a single message. The first set of common participants can have permissions to access the contents of the parent thread, the data structure is updated to grant the first set of common participants access to the child threads. When new participants are added to a first child thread, they are given access to the first child thread and restricted from accessing to the other child threads.

### BACKGROUND

There are a number of different types of collaborative systems that allow users to communicate. For example, some systems allow people to collaborate by sharing meeting chat messages, group chat messages, emails, etc. Some systems allow users to organize messages into different threads. In some systems, message threads can be organized into threads pertaining to specific topics. Although these features help users organize content to more readable formats, such systems can create security issues. For example, when users split a message thread into child threads, the dynamics of the user permissions for accessing the content can also change. As users are added to individual threads, some of which contain content of parent threads and sibling threads, some users may gain unintended access to certain content. Such an arrangement can create a number of attack vectors and expose stored content to a number of security threats.

Some existing systems attempt to address the aforementioned security issues by assigning a fixed set of permissions to child threads when they are created from an original thread. Although this arrangement helps address some security concerns, these security measures do not provide the flexibility that is needed to accommodate many user scenarios, particularly when users are added or removed from individual threads. When systems do not optimally provide permissions that can be dynamically adjusted, users may not be able to access all salient information shared within several message threads. This can lead to an inefficient user interaction model and lead to inefficient use of computing systems, particularly if users need to use additional resources to retrieve missed information. Thus, in addition to having a number of security issues, some current systems can create redundant use of computing resources and a number of inefficiencies with respect to the use of network resources, storage resources, and processing resources.

### SUMMARY

The techniques disclosed herein provide dynamic control of access permissions for split message threads of a communication system. Some configurations are directed to security features that utilize policies for managing privileges and access rights for users in multiple child threads split from a parent thread. A computing device stores a data structure that manages relationships between thread families, e.g., relationships between parent threads and child threads, as well as privileges and access rights for users for each thread. The computing device can update the permissions for select threads according to a policy as users are added or removed from other related threads. In one illustrative example, a parent thread having a first set of common participants can be split into multiple child threads. The first set of common participants can have permissions to access the contents of the parent thread, and the data structure can be updated to give the first set of common participants access to the contents of the child threads. When a new participant is added to a first child thread, that new participant is given access to the first child thread and access to the other child threads and the parent thread are restricted.

The techniques disclosed herein also provide a message thread management system that allows users to split a single message threads into child message threads. In some configurations, a system can display messages from an original thread and activate a split of the original thread by splitting content of a single message into the two threads. For instance, if a single message within a chat thread is related to two topics, the system can split the content of the single message into separate portions and associate the portions into two different chat threads that are respectively related to two different topics. A selection of a single message from an original thread can be split can be based on one or more factors, including a user input or attributes of the message. In response to a division of a single message, the system can parse portions of the message by topic and use that parsed content to generate messages in child threads. The child threads can each use customized topics and each child thread can be generated using content from messages of the original thread. The child threads can each be assigned user permissions as described herein, including but not limited to, dynamic assignment of user permissions and user access restrictions as users are removed and added to the parent and child threads.

In some configurations, the system can select a single message to be split based on an input indicating a particular message. The system can also select a single message for analysis based on attributes of each message. For instance, the system can select a message based on a time associated with the message, a position of the message within a user interface, the identification of select content in the message, or formats of the message. Once a message is selected, the system performs an analysis of the content of the message to determine if two or more topics are present, e.g., if the message is a multi-topic message. Responsive to determining that a selected message comprises two or more topics, the system causes a split of the selected message and generates two or more new child threads. Each child thread can be associated with an identified topic name and each may have messages containing a portion of the selected message. Each portion of the selected original message can be associated with messages in individual child threads each corresponding to a respective topic name. The system can also analyze other messages within the original thread to organize the remaining messages between the child threads.

In addition to improving the security of a system, the techniques disclosed herein can provide a number of other technical effects. For instance, by providing a display of messages that are organized in individual threads according to topics discovered within a single message, a computing device can effectively display information in a format that can allow a granular level of control of how content is organized. In addition, by allowing a system to split a single message into different threads, the system can more accurately identify topics and sort messages that are appropriate for each topic. Without the ability to split messages that pertain to multiple topics, a system may have to duplicate that message for between the new child threads. Specifically, existing systems that do not split a multi-topic message may place the message in a thread with a topic that does accurately align with the content of a multi-topic message. Alternatively, some existing systems may just place multi-topic messages in multiple threads. In either case, some existing systems do not allow for a granular level of accuracy when aligning each child thread topic with each multi-topic message. This can lead to user confusion when users are reading the new threads with inaccurate topic titles. These issues with existing systems also lead to a duplicative use of computing resources for storing some multi-topic messages in multiple threads.

When implementing the techniques disclosed herein, when a multi-topic message is split to more accurately align the message content with new child topics, a system can also increase the efficiency of a user's interaction with a device. When information is organized more accurately a user is less likely to miss salient information. Such benefits can increase the efficiency of a computing system by reducing the number of times a user needs to interact with a computing device to obtain information, e.g., prolonging meetings, retrieving meeting recordings, requesting duplicate copies of previously shared content, etc. Thus, various computing resources such as network resources, memory resources, and processing resources can be reduced.

The efficiencies of the analysis of a select message can also lead to other efficiencies. In particular, by displaying messages more accurately within topics, a system can reduce the number of times a user needs to interact with a computing device to obtain information. This can lead to the reduction of manual data entry that needs to be performed by a user. By reducing the need for manual entry, inadvertent inputs and human error can be reduced. This can ultimately lead to more efficient use of computing resources such as memory usage, network usage, processing resources, etc.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates a system used in an example scenario involving messages displayed within an original thread for an intra-message split initiated by analysis of a selected message.

FIG. 2 illustrates an example user interface displaying messages displayed in child threads generated from a split of an individual message of an original thread.

FIG. 3 illustrates an example user interface having a user interface element for adding a user to a child thread.

FIG. 4 illustrates an example user interface displaying messages to participants of two child threads including a new user to one of the new child threads.

FIG. 5 shows a transition of a data structure that modifies user permissions allowing access to a single child thread and parent thread when a user is added to the single child thread.

FIG. 6 shows a transition of a data structure that modifies user permissions allowing access to a single child thread and restricting access to a parent thread and other child threads when a user is added to the single child thread.

FIG. 7 shows a transition of a data structure that modifies user permissions removing access to a single child thread and a parent thread while maintaining restrictions to other child threads when a user is removed from the single child thread.

FIG. 8 shows a transition of a data structure that modifies user permissions removing access to a single child thread while maintaining restrictions to other child threads and maintaining access to a parent thread when a user is removed from the single child thread.

FIG. 9 is a flow diagram showing aspects of a routine for controlling message threads generated from intra-message divisions.

FIG. 10 is a computing system diagram showing aspects of an illustrative operating environment for the techniques disclosed herein.

FIG. 11 is a computing architecture diagram showing aspects of the configuration and operation of a computing device that can implement aspects of the techniques disclosed herein.

### DETAILED DESCRIPTION

The techniques disclosed herein provide dynamic control of access permissions for split message threads of a communication system. Some configurations are directed to security features that utilize policies for managing privileges and access rights for users in multiple child threads split from a parent thread. A computing device stores a data structure that manages relationships between thread families, e.g., relationships between parent threads and child threads, as well as privileges and access rights for users for each thread. The computing device can update the permissions for select threads according to a policy as users are added or removed from other related threads. In one illustrative example, a parent thread having a first set of common participants can be split into multiple child threads. The first set of common participants can have permissions to access the contents of the parent thread, and the data structure can be updated to give the first set of common participants access to the contents of the child threads. When a new participant is added to a first child thread, that new participant is given access to the first child thread and access to the other child threads and the parent thread are restricted.

The techniques disclosed herein also provide a message thread management system that allows users to split a single message threads into child message threads. In some configurations, a system can display messages from an original thread and activate a split of the original thread by splitting content of a single message into the two threads. For instance, if a single message within a chat thread is related to two topics, the system can split the content of the single message into separate portions and associate the portions into two different chat threads that are respectively related to two different topics. A selection of a single message from an original thread can be split can be based on one or more factors, including a user input or attributes of the message. In response to a division of a single message, the system can parse portions of the message by topic and use that parsed content to generate messages in child threads. The child threads can each use customized topics and each child thread can be generated using content from messages of the original thread. Although one illustrative example described herein involves the division of an original thread based on the detection of a multi-topic message, and a split of that the topic message, the generation and updates to the permissions can also be applied to any other type of thread that is divided using other methods. Thus, updates to the user permissions described herein can apply to any family of threads where child threads that are generated from a single parent thread, regardless of whether a single message is split or not.

The disclosed techniques address a number of technical problems and provide a number of technical effects. In some aspects of the present disclosure, the techniques disclosed herein provide a number of enhanced security measures to restrict user access to certain clusters of data based on user memberships of message threads. The restriction of user access and the dynamic nature of also granting user access provides a higher level of security while allowing a system to accommodate a number of user scenarios where users need to dynamically grant and revoke permissions.

The techniques herein can also optimize interface displays of message threads for improving user interaction models and improving efficiencies with respect to computing resources. For example, by providing a display of messages that are organized in individual threads according to topics discovered within a single message, a computing device can effectively and more accurately display information in a format that can allow a granular level of control of how content is organized. This allows a system to display more accurate associations between messages and topics. In one illustrative example, by allowing a system to split a single message into different threads, the system can more accurately identify topics and sort messages that are appropriate for each topic. Without the ability to split a message that pertains to multiple topics, a system may have to duplicate that message for different threads. In addition, a system that does not allow for a multi-topic message to be split creates a scenario where that message may be placed under a topic under one selected topic, which may not be entirely accurate for all portions of that message. In either case, this does not allow for a granular level of accuracy for systems that align individual messages with individual threads pertaining to particular topics. The techniques disclosed herein also provide a number of other technical benefits that can reduce redundant requests for information that is missed when messages are not accurately organized with threads and/or topics. Among other technical effects, improved user interactions disclosed herein lead to more efficient use of computing resources such as memory usage, network usage, processing resources.

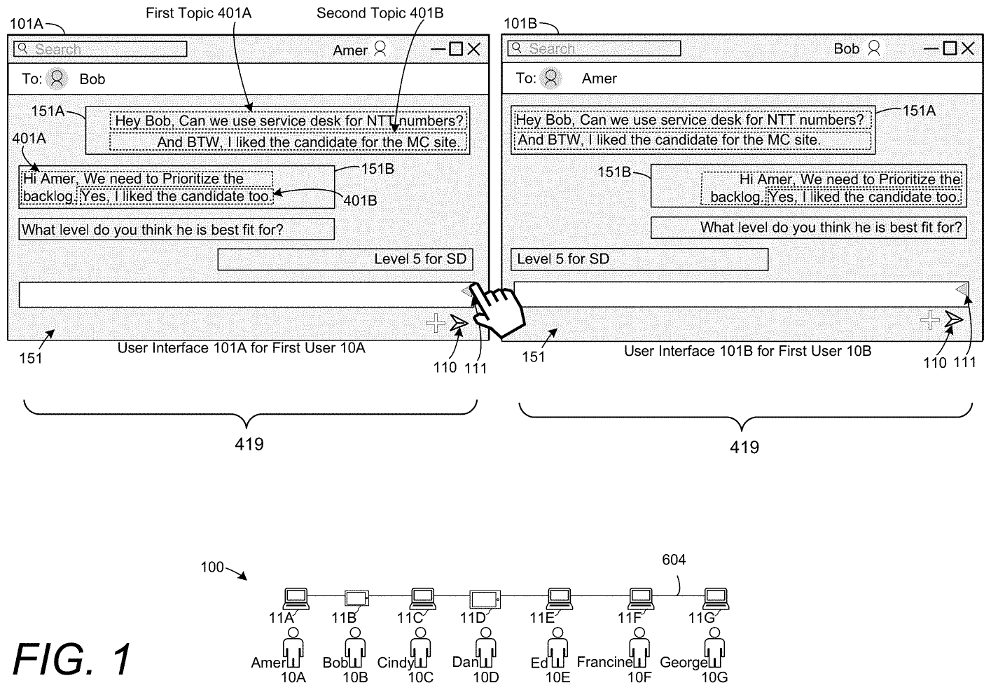

Referring now to FIG. 1, aspects of a system 100 are shown and described below. In this example, individual computing devices 11 are interconnected with a communication session 604 configured for exchanging messages 151 and managing permissions on a per user and per thread basis. Each user 10 is associated with a computing device 11 and each computing device 11 can display a user interface 101. In this example, a first user interface 101A is displayed on a screen of a first computing device 11A for a first user 10A. A second user interface 101B is displayed on a screen of a second computing device 11B for a second user 10B. Other users 10C-10G can also view similar user interfaces for those who are participating in a particular thread and who have permission to view shared messages.

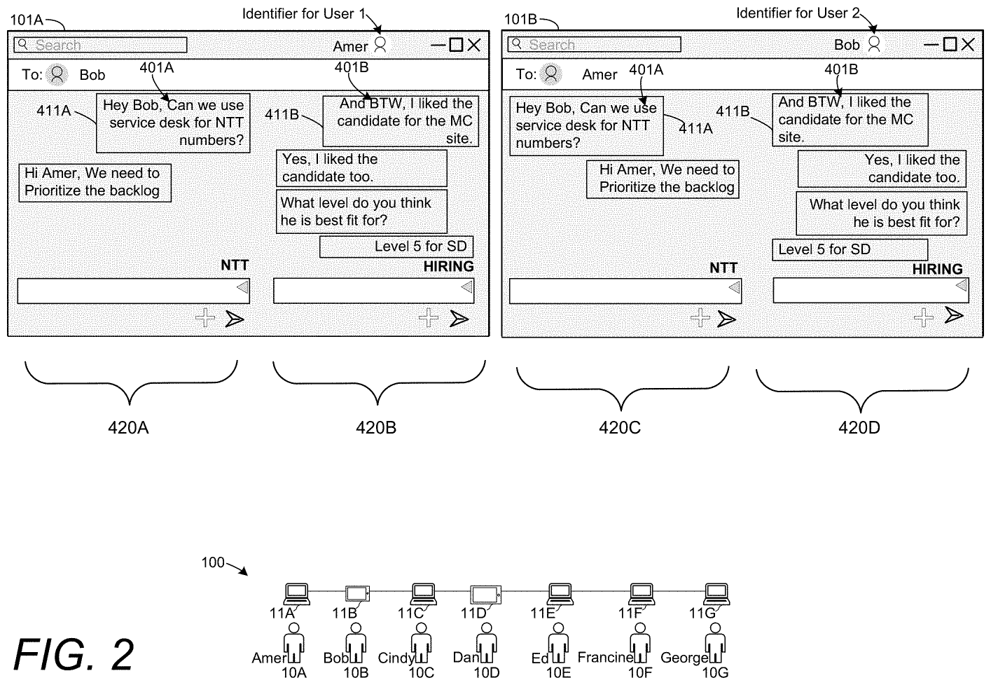

FIGS. 1 and 2 show a process where a computer splits a thread. In this example, the first user 10A and the second user 10B are using their respective computers to send messages to one another. As shown in FIG. 1, an original thread 419 comprises a set of messages 151. The system activates a split of the original thread 419 to generate two child threads 420 shown in FIG. 2. The child threads 420 can include messages 411 having text content from a multi-topic message of the original thread 419, such the first message 151A. As shown, the first message 151A has text content pertaining to multiple topics 401, e.g., a first section of text pertaining to a first topic 401A, e.g., NTT numbers, and a second section of text pertaining to a second topic 401B, e.g., hiring.

In one of the initial stages of a process of splitting a message, the system can cause the first computer 11A to display a user interface 101A comprising an original thread 419 of a plurality of messages 151. A first message 151A from the original thread can include text content. In some configurations, the system can analyze the text content of a select message, such as the first message 151A, of the original thread 419 determine if the select message has multiple topics. The analysis of the select message may be initiated by an automatic selection of a message based on the criteria disclosed herein. Alternatively, the analysis of the select message may be initiated by an input at a user interface element 111 by any participant. The analysis can be initiated while a message is being composed in a text entry filed, e.g., before the user provides an input at a send button 110, or the analysis can be initiated after all messages are sent to a thread.

The system can determine if a single message has multiple topics by identifying at least a first topic 401A and a second topic 401B within the text content of the select message of the messages 151 of the original thread 419. For illustrative purposes, in this example, a first text portion of a select message, e.g., the first message 151A, of the original thread 119 is associated with the first topic 401A and a second text portion of the select message is associated with the second topic 401B.

The analysis of the text to determine topics within a message can be based on any suitable technology. In some configurations, the analysis to determine topics within a message can be based on the presence of predetermined words or predetermined word combinations that are in a single message. In some configurations, the analysis to determine topics within a message can also be based on the presence of word categories. In one illustrative example, predetermined nouns or verbs found within a message can be identified as a topic candidate. Predetermined words can also include categories of words like team names, product names, etc. Thus, any of the predetermined words, which may be retrieved from a database, can be used to identify topics within a message. Text in a predetermined format can also be selected as a topic candidate. For example, words in all cap characters or words in bold text may be selected as a topic candidate.

In some configurations, predetermined keywords that are found within a select message can be identified as a topic candidate. Keywords can be stored in a database and aligned with, or labeled as, a topic. The database can also maintain scores for each keyword and/or topic. When a keyword is identified in a message, a topic candidate can be selected. Topic candidates can also be selected using the other techniques disclosed herein. The topic candidates can be scored and ranked, and topic candidates having a threshold score, e.g., a threshold priority, can be selected as a topic for a child thread.

The system can also select text portions of a message and associate each portion with a particular topic. The text portions may be selected based on punctuation, text spacing, or the position of some text characters. In the example of FIG. 1, based on the punctuation, the system can determine that there are two sentences. Each sentence can be analyzed to derive a topic candidate for each portion of text. For illustrative purposes, consider a scenario where the text is analyzed, and the system determines that the first sentence within the select message 151A pertains to a first topic 401A and a second sentence within the select message 151A pertains to a second topic 401B. In such an example, certain keywords, such as the subject of a phrase can be selected as a topic candidate, such as NTT, for the first topic 401A. In another example, a topic candidate can be selected from a list of topics that are associated with keywords. In such an example, the system can identify one or more keywords within a message, such as “candidate,” and automatically select a topic candidate, such as “hiring,” based on that keyword. If the topic candidate meets one or more criteria, such as a topic candidate having a priority threshold, that type of topic candidate can be selected as a topic for a new thread. This example is provided for illustrative purposes and is not to be construed as limiting. It can be appreciated that any suitable technology for identifying a topic within a collection of text can be utilized with the techniques disclosed herein.

If the system determines that two topic candidates of a single message are related, e.g., the topic candidates are the same or they are synonymous to a threshold degree, the system may determine that the associated message is a single-topic message. Such a determination can be made by scoring each topic candidate. For example, if a select message has a first portion, e.g., a first sentence, with the word “candidate” and another portion with the word “resume,” a first score can be associated with a word such as “candidate” and another score can be associated another word such as “resume.” These scores may indicate a threshold level of likeness given that they are both related to hiring. Thus, when a system detects a message having two portions with these two keywords having a threshold level of likeness, the system may not generate new child threads.

When a system detects a message having two portions with two keywords, and corresponding topic candidates that do not have a threshold level of likeness, the system may generate new child threads for each topic candidate. For example, a word in a first portion of a message, such as “NTT,” may be associated with a first score and another word in a second portion of the message, such as “candidate,” may be associated with a second score. These scores may not indicate a threshold level of likeness given that they are not related to a similar topic. Thus, a message having two portions with these two words that do not have a threshold level of likeness may be deemed as a multi-topic message. Once a single message is deemed to be a multi-topic message, the system can invoke one or more operations for splitting that message into two or more child threads as well as organizing other messages of the original thread into individual child threads.

In some embodiments, a system can also select one or more messages within the original thread 419 for analysis. Thus, the system may only analyze select messages meeting one or more criteria. By limiting the number of messages that are analyzed to detect multiple topics, a system may introduce further efficiencies with respect to computing resources. In one example, the system may only select messages having multiple sentences or multiple phrases. In such an example, any message having more than one sentence can be selected for analysis. In another example, the system may select messages that have more than a threshold number of words or characters. In such an example, only messages having more than a threshold number of words or threshold number of characters can be selected for analysis. In other examples, a system may select a message for analysis based on the position of the message within a user interface. This may include a position of a message within a thread or a viewing area, e.g., the last message of a thread or a message that is at the top of a viewing area, may only be selected for analysis. In yet another example, a system may select a message for analysis based on a timestamp or a state associated with the message. In such an example, a most recently received message may be selected for analysis, or a system may only select a message that is recently composed but not sent, etc. In other examples, a system may only select messages that have been received within a predetermined time period, or a system may only select message that have been received outside of a predetermined time period.

Other characteristics of a message, such as a format, can be used to select a message for analysis. This may include a font type, a threshold number of capital letters, threshold number of capital letters per word, or formatting combinations, e.g., a threshold number of characters in bold text, etc. Once a message is selected for analysis, the system determines if the message contains multiple topics. These examples are provided for illustrative purposes and are not to be construed as limiting. The system can utilize any property, condition, state or any combination of factors described herein to determine if a message is to be selected for analysis.

When the system determines that there are two or more topics discovered within a message, the system can initiate a split of the message and the original thread 419 to generate child threads and divide the text content of the message between the generated threads. In some configurations, responsive to the identification of multiple topics, e.g., the first topic and the second topic, within the text content of the original message 151A, the system can cause the user interface 101A shown in FIG. 1 to split the original thread 419 and the original message 151A and transition to an updated user interface shown in FIG. 2. FIG. 2 shows an updated user interface 101A for the first user that shows a first child thread 420A and a second child thread 420B that is based on the split of the original thread 419. Similarly, a set of child threads, the third child thread 420C and the fourth child thread 420D, that are based on the split of the original thread 419 can be displayed on an updated user interface to a second user.

The updated user interface for each user can include a first message 411A positioned in a first new child thread 420A and a second message 411B positioned in a second new child thread 420B. The first message 411A can comprise the first text portion of the original message 151A that is associated with the first topic 401A, e.g., “Hey Bob, Can we use service desk for NTT numbers?” In addition, the second message 411B can include the second text portion of the original message 151A that is associated with the second topic 401B, e.g., “And BTW, I liked the candidate for the MC site.” Once the child threads are generated, the system can divide the remaining messages of the original thread into each child thread.

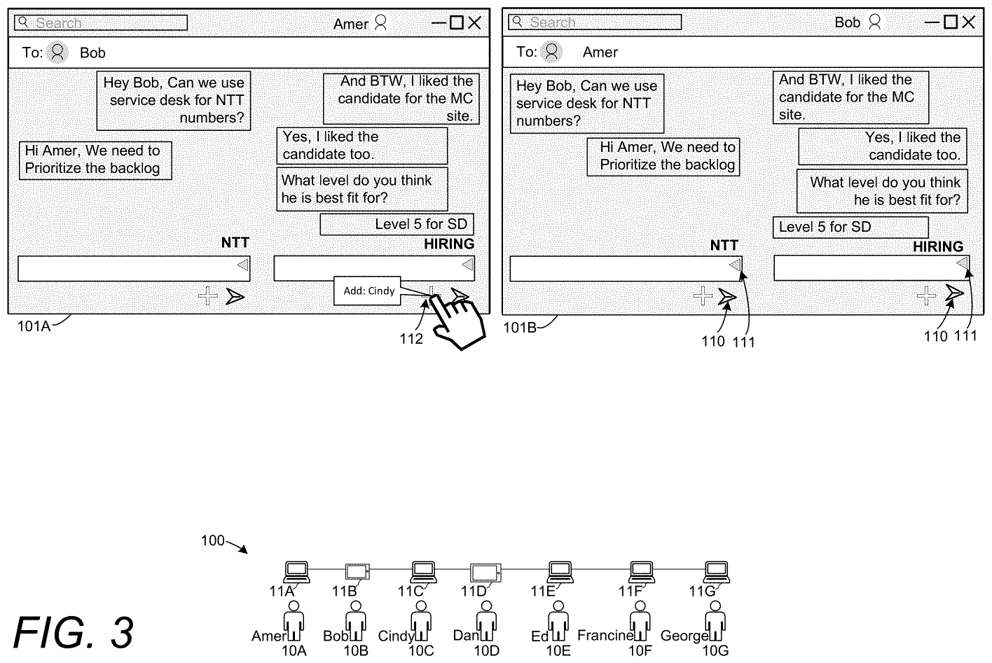

Now turning to FIG. 3, shows a user input provided at a graphical element 112 at one of the user interfaces, such as the first user interface 101A. The user input at the graphical element 112 invokes operations for causing a new person to be added to a particular thread. In this example, a third user 10C, Cindy, is added to the second thread. Although this example illustrates a user input provided at a user interface, they can be appreciated that the input for invoking the addition of a new user to a particular thread can be provided in a number of different ways. For instance, a voice command or other gestures may be provided to a computer where the gestures or the voice command indicate the identity of a person to be added to a thread. In addition, the user input can also be in the form of a confirmation of a request. In such an example, the third user, Cindy, may request to be added to a thread and one of the users participating in the conversation, such as the first user, to can approve the request.

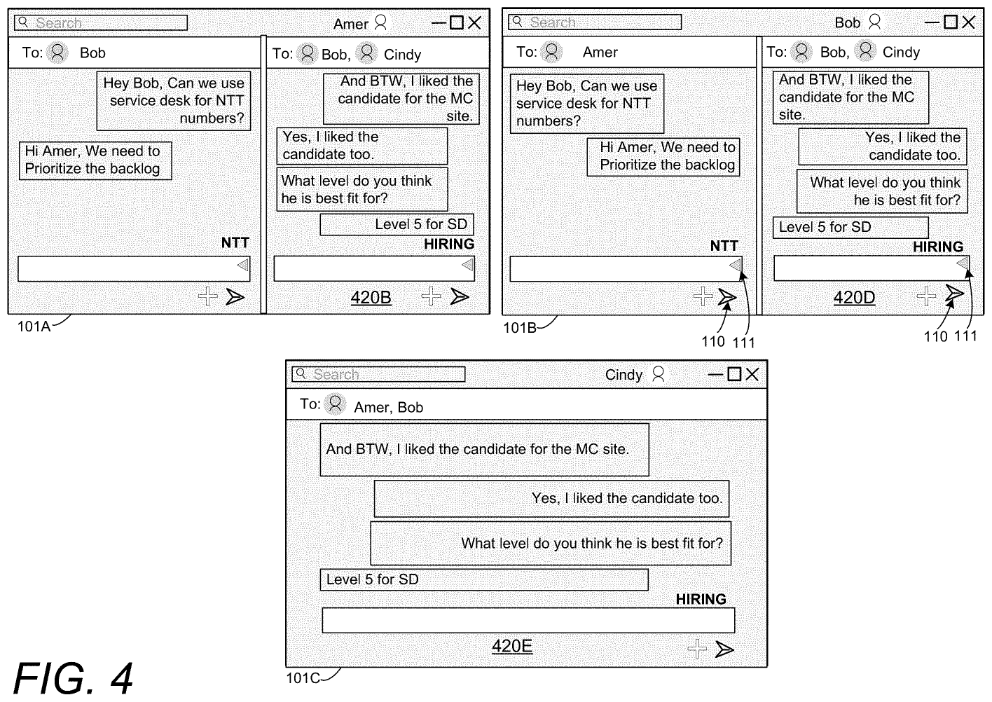

As shown in FIG. 4, in response to the addition of the third user, the system can cause a display a third user interface 101C on a third computing device associated with the third user. The third user interface can include the display of a new thread 420E that corresponds with, and contains the same messages as, the second thread 420B of the first user and the second thread 420E of the second user. As shown, this child thread of the original thread 419 has an associated topic, labeled as “Hiring.” Thus, each time the third user provides a new message to the new thread, that new message is shared with the other users and displayed on the corresponding threads, second thread 420B of the first user and the second thread 420E of the second user. Similarly, each time the first user provides a new message to the second thread 420B of the first user interface or when the second user provides a new message with the second thread 420E of the second user interface, those new messages are shared with the third user and displayed on the new thread 420E.

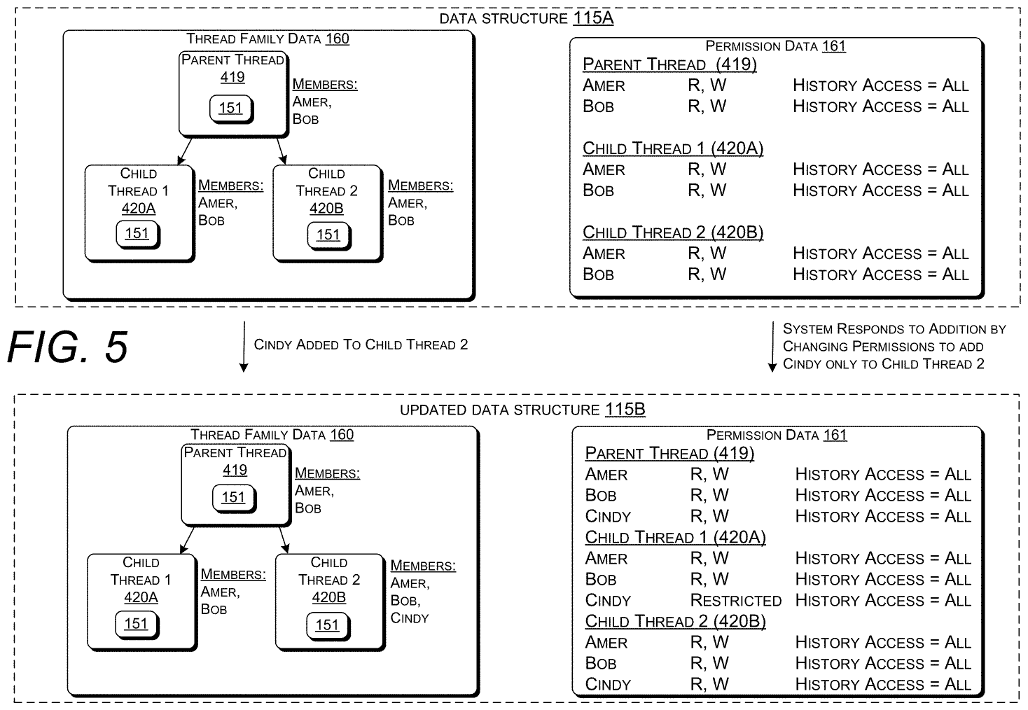

As shown in FIG. 5, when the new user is added to a child thread, such as the second thread 420B, the system can update a data structure 115 defining permissions for the third user in addition to causing the display of the new thread 420E on a third device 11C of the third user 10C. In some configurations, the system can update the permissions to allow the third user to view the contents of the new thread and contribute messages to the new thread. In addition, the permissions are configured such that the third computing device associated with the third user is restricted from receiving any data associated with the first child thread 420A of the first user or the first child thread 420C of the second user. The third computing device may have access to the contents of the original thread 419, and in some instances, the third computing device may have access to messages of the original thread 419.

For illustrative purposes, permissions that indicate that a user is restricted from reading content from a thread can mean that a computing device associated with a user that is prevented from receiving that particular content, which can mean messages or any information defining a thread. In addition, when a user is restricted from writing to a message thread, e.g., they are not participants of a thread, the device associated with that user cannot write to any thread or modify any data structure disclosed herein.

FIG. 5 shows the data structure 115 in two states, a first state of the data structure 115A in the top half of the figure, which is a state of the permissions prior to the addition of the new user, e.g., the third user, and after the original thread 419 is split into the first child thread 420A and a second child thread 420B. The first state of the data structure 115A shows a state of the thread family data 160 where the original thread 419, also referred to herein as the parent thread 419, is shown to have a hierarchical position above the first child thread 420A and the second child thread 420B. As shown, when the child threads are generated from the parent thread the system utilizes the user identities of the participants of the parent thread and lists those identities as participants in each child thread. As shown in the permission data 161, each user that was participating in the parent thread also has identical permissions for each child thread.

The second state of the data structure 115B shows a state after the third user is added to the second child thread 420B. As shown, the thread family data 160 of the second state of the data structure 115B shows the original thread 419 and the child threads 420 having a similar hierarchy as the first state of the data structure. However, in the second state of the data structure 115B the permission data 161 shows that the third user, Cindy, is now a member of the second child thread 420B. In addition, in response to the third user being added to the second child thread 420B, the system transitions the permission data 161 in the second state of the data structure 115B to allow the third user to read and write to the second child thread 420B and the parent thread 419. At the same time, the permission data 161 in the second state of the data structure 115B shows that the third user is restricted from reading or writing messages to the first child thread 420B.

Also shown in FIG. 5, the system may select individual messages 151 from the original thread 419 to be associated with each child thread 420. The messages of each child thread 420 can be generated from splitting individual messages of the original thread. In addition, other messages 151 of the original thread can be selected to be associated with each child thread. For instance, with respect to FIG. 1, the message “Level 5 for SD” can be selected by a user input or by an identification of one or more keywords associated with a topic. That message 151 can then be associated with one of the child threads, as shown in FIG. 2. Those associations can be maintained by the data structure, as shown in FIG. 5. For illustrative purposes, each thread (both parent and child threads) within the thread family data can represent a thread container which associates a collection of messages that are associated with a particular topic, e.g., a thread title such as “NTT,” of the thread. Each thread container can also include a thread identifier and data defining a thread type, e.g., parent or child. Each thread container can also include a thread identifier for each related family member. For instance, the parent thread 419, also referred to herein as an original thread 419, can be a container also storing identifiers each child thread. The identifiers can utilize to obtain data indicating relationships between threads, relationships which are represented by the lines between the representations of the thread containers of the thread family data 160.

In the embodiments disclosed herein, the permissions can also be modified to accommodate a recipient-controlled security model. Thus, users can modify the permissions to identify users that can send them messages and users that are restricted from sending them messages. For instance, in the example of FIG. 5, once the third user is added to the second child thread, the system can provide the original set of users, e.g., the first user or the second user, with a notification announcing the addition of the third user. The system can also provide an input mechanism, e.g., a menu option or a voice input prompt, that allows the original set of users to indicate if the third user can send them messages. For instance, the first user can indicate that the third user can send the first user messages within the second child thread, while the second user can indicate that the third user is restricted from sending messages to the second user messages within the second child thread. Thus, the permissions can be modified to associate a newly added user with each original user with specific permissions permitting or denying the new user's ability to communicate messages with each original user.

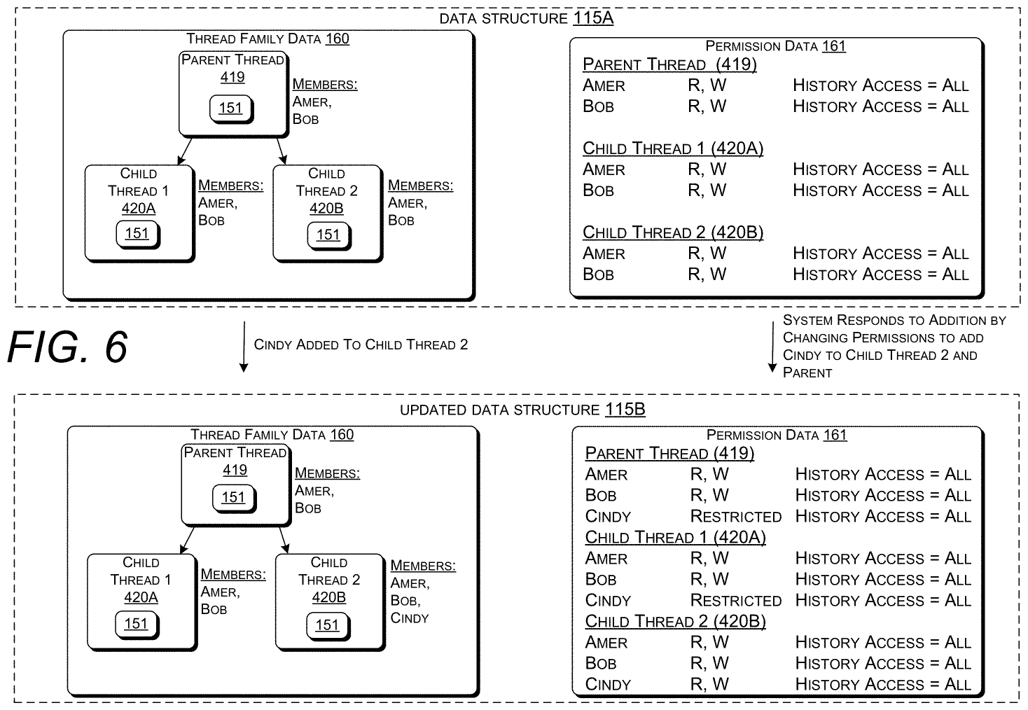

FIG. 6 shows another example of the data structure where the system causes a transition of the data structure from a first state to a second state after the third user is added to the second child thread 420B. In this embodiment, in response to the third user, Cindy, being added to the second child thread 420B, the system transitions the permission data 161 in the second state of the data structure 115B to allow the third user to read and write to the second child thread 420B. At the same time, the permission data 161 in the second state of the data structure 115B shows that the third user is restricted from reading or writing messages to the first child thread 420B and the parent thread 419.

A restriction to the parent thread 419 can mean that a user, such as the third user, is restricted from reading any thread that is maintained in an original state. This may occur when, for instance, a computer has denied a split request that was initiated by another computer. For instance, consider a scenario where the first computing device has initiated a split of the original thread 419. In such an instance, the first computing device can transition from a first user interface format having the original thread 419, as shown in FIG. 1, to a second user interface format having to child threads, a first child thread 420A and a second child thread 420, as shown in FIG. 2. In this scenario, the first computing device may send a split request to the second computing device. The second computing device can accept the split request and transition to the interface format 101B having the child threads as shown in FIG. 2. The second computing device can also deny the split request and maintain the original user interface format 101B shown in FIG. 1. In this scenario where the second computing device maintains the original user interface format, e.g., displaying the original thread 419, the second computing device may deny access to a user, such as the third user, if that user does not have access to the original thread. By denying access to the original thread, e.g., the parent thread, the system may restrict access to messages that were not inherited by the child threads. This adds another level of security and a more granular level of control of access permissions in that historical data that is not transferred to a child thread from a parent thread can be protected from added users such as the third user.

In some configurations, when a user is added to a child thread, one or more designated users, such as a participant of a parent thread or a sibling thread, can establish a timeline for the viewing permissions for the new user. For instance, when the third user is added to the second child thread, the first user or the second user can set a timeline that controls the number of messages that are viewable by the third user. In one illustrative example, when the third user, Cindy, is added to the second child thread, and the second child thread comprises messages inherited from the parent thread 419, the first user can provide an input that indicates a number of messages, or a time threshold for messages, that controls the system on how far back the third user can view messages that are inherited in the parent thread. The permission data is associated with the third user can be configured to indicate that the third user is restricted from viewing or receiving any message that predates a particular time. In another example, the permission data associated with third user can be configured to indicate that the third user can only see a history going back 50 messages, e.g., a predetermined number or a predetermined range, from the time that they are added to the child thread. The permission data can also define a timeline, a number of messages, or other criteria identifying select messages of the parent thread that a new user of a child thread can access. Thus, a new user of a child thread, such as the third user can access a specific part of a history of a parent thread, which may include multiple topics. This may be beneficial in scenarios where a parent thread is split into many child threads and a number of messages of that parent thread were not inherited by each child thread.

In the examples described above, the system can restrict access to individual messages of a child thread when a new user is added to the child thread. For instance, when a user joins a child message, based on a policy established in the data structure disclosed herein, the system can select a set of messages, which can be any set of individual messages, and permit the new user to receive and view the set of messages. Referring to the example described above, permission data 161 stored at any client or at a server can be configured to permit the third computing device of the third user to access a set of messages of the second new thread that meet one or more criteria. The one or more criteria can be applied to a set of messages of the second new thread are provided to the second new thread prior to the addition of the third user. This controls how far back the new user, e.g., the third user, can access messages that were provided to the second new thread prior to the user joining the second new thread. The permissions can also allow the new user to add and view messages that are contributed to the second new thread after the user has joined the second new thread. The one or more criteria can be configured to select the set of messages of the second new thread is based on a time threshold from a time the third user was added to the second new thread or a predetermined number of messages sent prior to the addition of the third user. The one or more criteria can be provided by an input of the first user or the second user, e.g., the participants of the original parent thread.

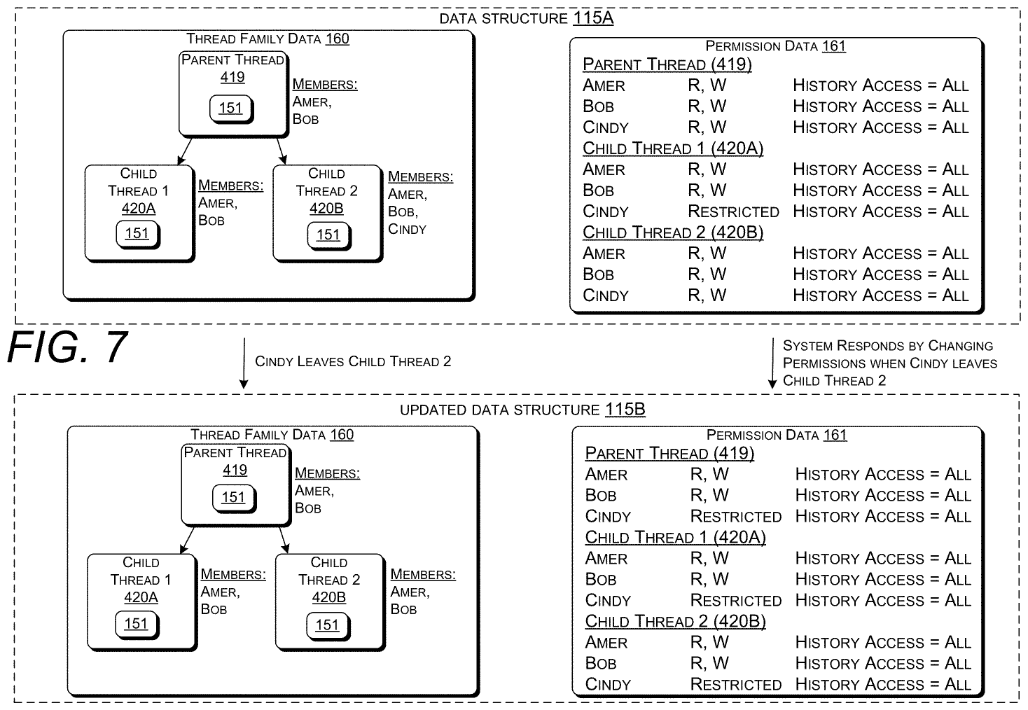

In some configurations, the system can update the data structure based on other actions that modify a participant list of a thread. In one illustrative example, the system can dynamically and automatically update one or more permissions when a user, such as the third user, is removed from a child thread. Specifically, after a user is added to a child thread that is split from a parent thread, the read and write permissions for that user can be automatically revoked for that child thread. In addition, in some configurations, the read and write permissions for that user can be also revoked for the corresponding parent thread. This example is shown in shown in FIG. 7. These operations for revoking the permissions to access the child thread(s) and/or the parent thread may be performed in response to the user leaving a child thread subsequent to that user being added to that child's red after a split.

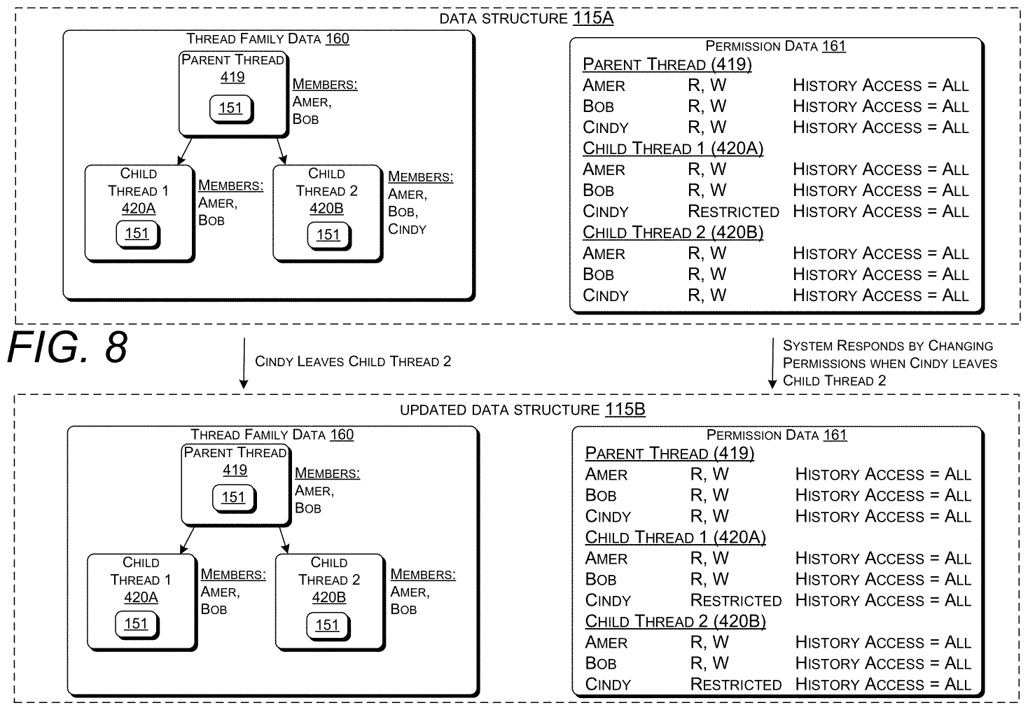

FIG. 8 shows another scenario where the third user, Cindy, leaves the second child thread and, in response, the system updates the permissions to restrict the third user form the second child thread but leaves the permissions allowing the third user to access the parent thread. This embodiment may also include criteria that can be used to select a certain set of messages in the parent thread. This may include a timeline, a number of messages, or other criteria that identifies messages pertaining to a particular topic.

The system disclosed herein also modifies the permission data for the original members of the parent and child threads, e.g., the first user and the second user. For example, consider a scenario where one of the original members, such as the first user, leaves a child thread after the third user has joined the child thread. In response, the system removes access rights to that child thread but maintains rights to the other sibling and the parent. In some configurations, in response to the first user leaving a child thread after the third user has joined the child thread, the system removes access rights to that child thread and all sibling threads but maintains the access rights to the parent thread. In some configurations, in response to the first user leaving a child thread after the third user has joined the child thread, the system removes access rights to that child thread, one or more sibling threads, and the parent thread.

In such embodiments, the system can receive an indication causing a removal of the second user from the second new thread. Responsive to the indication causing the removal of the second user from the second new thread, the system can update the permission data to restrict the second computing device associated with the second user from accessing the messages of the second new thread while maintaining access to the first new thread.

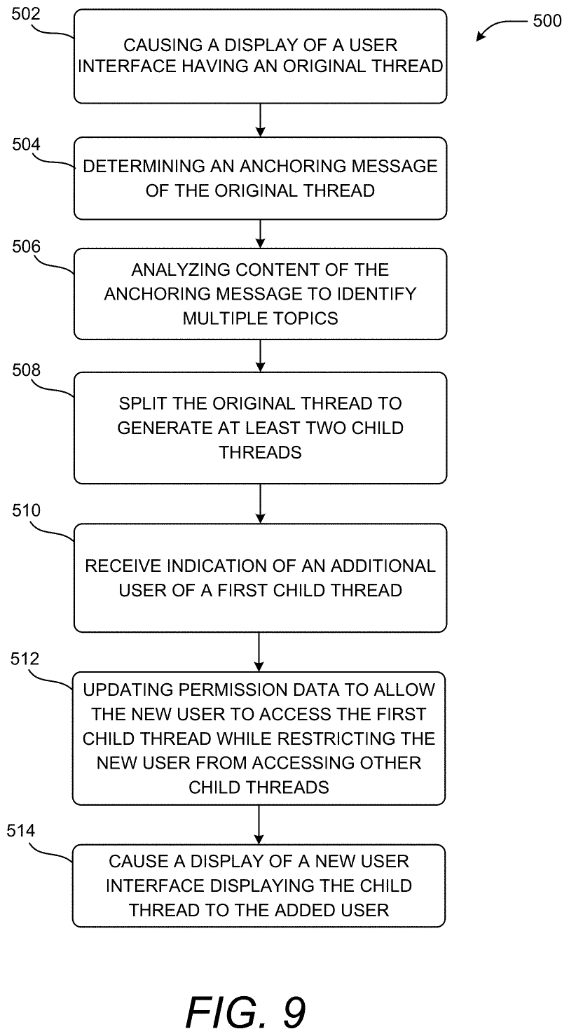

FIG. 9 is a diagram illustrating aspects of a routine 500 for enabling users to split message threads into child message threads. It should be understood by those of ordinary skill in the art that the operations of the methods disclosed herein are not necessarily presented in any particular order and that performance of some or all of the operations in an alternative order is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entirety. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Although the example routine described below is operating on a system, e.g., one or more computing devices, it can be appreciated that this routine can be performed on any computing system which may include any number of computers working in concert to perform the operations disclosed herein.

Thus, it should be appreciated that the logical operations described herein are implemented as a sequence of computer implemented acts or program modules running on a computing system such as those described herein and/or as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

Additionally, the operations illustrated in FIG. 9 and the other FIGURES can be implemented in association with the example presentation user interfaces UI described above. For instance, the various devices and/or modules described herein can generate, transmit, receive, and/or display data associated with content of a communication session e.g., live content, broadcasted event, recorded content, etc. and/or a presentation UI that includes renderings of one or more participants of remote computing devices, avatars, channels, chat sessions, video streams, images, virtual objects, and/or applications associated with a communication session.

The routine 500 includes an operation 502 where the system causes one or more computing devices to display a user interface 101A comprising an original thread 419 of a plurality of messages 151. The user interface can include an original message 151A of the plurality of messages 151 comprises text content. An example of the original thread 419 is shown in FIG. 1A.

Next, at operation 504, the system can select an anchoring message from the original thread. The anchoring message, also referred to herein as the “selected message,” can be a message that is analyzed to detect the presence of multiple topics within a single message. As described herein, the anchoring message can be selected based on a number of factors, including, a location of the message within a user interface, a location of the message within a thread, a timestamp associated with the message, a drafting status of a message, punctuation or formatting of the message, or any other characteristic or attribute of a message. For instance, a recently received or a recently sent message can be selected for analysis. In other embodiments, the selected message may include a message being composed by user. The techniques disclosed herein can also select a range of different messages for analysis. For instance, messages containing multiple sentences, or a predetermined number of characters or words can be selected for analysis. In some embodiments, operation 504 can be in response to an input for invoking a split or operation 504 can be in response to a detection of any message characteristic, e.g., format, content, or position, or any message attribute, e.g., a timestamp or permissions, that meet one or more criteria.

Next, at operation 506, the system can cause an analysis of the selected message, e.g., the anchoring message. In some configurations, the system can analyze the text content of the selected message, such as a first message or a most recent message. In the example of FIG. 1A, a first message 151A is selected and analyzed to identify a first topic 401A and a second topic 401B within the text content of the original message 151A of the plurality of messages 105. A first text portion of the original message 151A is associated with the first topic 401A and a second text portion of the original message 151A is associated with the second topic 401B. In some embodiments, operation 506 can be in response to an input for invoking a split or operation 504 can be in response to a detection of any message characteristic, e.g., format, content, or position, or any message attribute, e.g., a timestamp or permissions, that meet one or more criteria.

Next, at operation 508, the system can cause a split of the select message and cause the original thread to be split into multiple child threads. Operation 508 can be executed in response to a number of actions, the identification of multiple topics within a message, a user input dictating a message split, or other activities described herein. In some configurations, responsive to the identification of the first topic and the second topic within the text content of the original message 151A, e.g., multiple topics in a message, the system can cause the first user interface 101A to split the original thread 419 and the original message 151A by displaying a first message 411 positioned in a first new thread 420A and a second message 412 positioned in a second new thread 420B, wherein the first message 411 comprises the first text portion of the original message 151A that is associated with the first topic 401A, and wherein the second message 412 comprises the second text portion of the original message 151A that is associated with the second topic 401B. In some embodiments, operation 508 can be in response to an input for invoking a split or operation 504 can be in response to a detection of any message characteristic, e.g., format, content, or position, or any message attribute, e.g., a timestamp or permissions, that meet one or more criteria. Operation 508 can also be performed in response to operation 506 and/or operation 504.

In some configurations, the split of the original thread is only performed in response to determining that the first topic or the second topic have associated scores that exceed a threshold priority score. The threshold priority score may be different for each user and stored in the metadata. Thus, the topics of NTT and Hiring may cause a spilt for a first user but not cause a split for a second user that has a higher threshold priority score for such topics versus the first user. Thus, a second computer, such as the examples shown herein, may deny a split request based on a user input or based on priority thresholds for each topic and/or each user. In one example, responsive to the input for invoking instructions to split the original thread 419, the system can cause the original user interface 101A to transition to an updated version of the user interface 101A which displays the result of a split the original thread 419, e.g., a first message 411 within the first new thread 420A associated with the first topic 401 and displaying a second message 412 in the second new thread 420B associated with the second topic 402, wherein the first message 411 comprises the first text portion split from the original message 151A, and wherein the second message 412 comprises the second text portion split from the original message 151A.

During operation 508, the system may select individual messages 151 from the original thread 419 to be associated with a child thread 420. As described herein, the messages of each child thread 420 can be generated from splitting individual messages of the original thread. In addition, other messages 151 of the original thread can be selected to be associated with each child thread. For instance, with respect to FIG. 1, the message “Level 5 for SD” can be selected by a user input or by an identification of one or more keywords associated with a topic. That message 151 can then be associated with one of the child threads, as shown in FIG. 2. Any subset of messages of the original thread can be associated with each child thread. One or more filters can also be applied to select a subset of messages from the original thread. For instance, time limits or other thresholds can be utilized to limit the number of messages selected from the original thread for each child thread.

Next, at operation 510, the system can receive an indication that an additional user is to be added to a child thread. As described herein, the indication can be in the form of a user input by any user participating in a thread. The indication can provide an identity of a user, such as the third user. The indication can be an input provided by a voice command, a gesture, or any other input identifying a selected user to be added to a child thread.

Next, at operation 512, the system can update permission data and other aspects of a data structure defining relationships between parent threads and child threads. For example, permission data may be updated to associate the identity of the added user with read/write permissions that allow the added user to access a child thread of a parent thread. The update can also configure the permission data to restrict the added user from accessing other child threads of the parent thread. In addition, the update can be configured to restrict the added user from accessing the parent thread. Alternatively, the update can be configured to allow the user to access the parent thread, which may include a portion of the messages of the parent thread. The update can cause the display of a user interface 101C of a computing device associated with the added user.

In some configurations, responsive to an input causing an addition of a third user 10C to the second new thread 420B, operation 512 can include modifying the permission data 161 to allow a third computing device 11C of the third user 10C to display messages associated with the second new thread 420B, wherein the permission data 161 restricts the third computing device 11C of the third user 10C from displaying messages associated with the original thread 419 and the first new thread 420A. This is shown in FIGS. 1 and 2C. As a new user is added, the system can include managing user privileges and access rights of users in multiple child threads split from a parent thread, in which the child threads start with the same common users in parent thread. The system only adds the user, e.g., the third user, to the selected child thread while restricting the added user from the other threads, e.g., the other child threads and/or the parent thread.

In some embodiments, the permission data can be configured to control a level of access for the added user. For instance, if the second child thread had fifty messages sent to the thread by the first user and second user, the first user, second user, or a policy can control how many of the existing fifty messages the added user can receive and view. In such embodiments, a method can include permission data 161 that is configured to permit the third computing device of the third user to access one or more messages of the second new thread that meets one or more criteria. For illustrative purposes, the one or more messages of the second new thread were provided to the second new thread prior to the addition of the third user. In the example above, the criteria can be used to determine the limits in which Cindy can view the history of the second child thread. For instance, the one or more criteria can be based on a time threshold from a time the third user was added to the second child thread and/or a predetermined number of messages sent prior to the time the addition of the third user. For example, a system may restrict Cindy's computer from receiving more than a predetermined number, e.g., twenty messages of a set of fifty messages that existed in the second child thread prior to her participation. The system may restrict Cindy's computer from receiving messages that existed in the second child thread for more than a predetermined time or time period, e.g., Cindy may not be able to see messages that were sent more than two weeks before the event that added her to the second child thread.

The system can also be configured to update the permission data when the added user leaves the child thread. In some configurations, access permissions allowing the user to read and write to the child thread may transition to a restriction preventing the user from reading and writing to the child thread. In addition, the system can also independently control the user's access to the parent thread and other sibling threads.

Next, at operation 514, the system can cause a display of a new user interface 101C on the third computing device 11C of the third user 10C, the new user interface 101C comprising the messages associated with the second new thread 420B. This can be executed while the permission data restricts the third computing device 11C of the third user 10C from displaying the messages associated with the original thread 419 and the first new thread 420A.

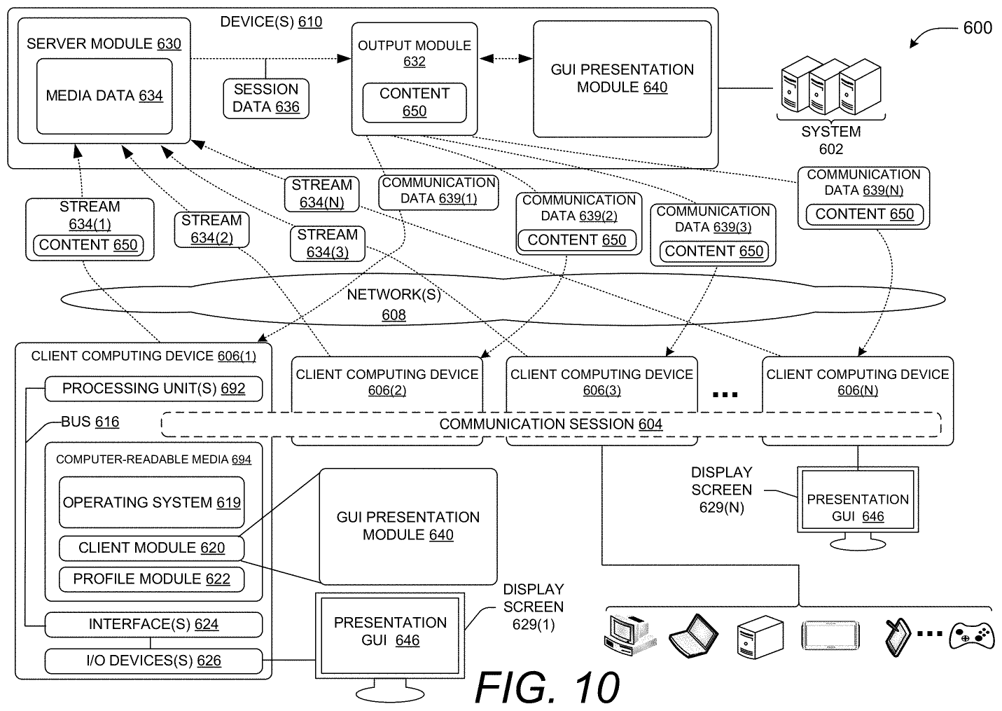

FIG. 10 is a diagram illustrating an example environment 600 in which a system 602 can implement the techniques disclosed herein. It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

In some implementations, a system 602 may function to collect, analyze, and share data that is displayed to users of a communication session 604. As illustrated, the communication session 603 may be implemented between a number of client computing devices 606(1) through 606(N) (where N is a number having a value of two or greater) that are associated with or are part of the system 602. The client computing devices 606(1) through 606(N) enable users, also referred to as individuals, to participate in the communication session 603.

In this example, the communication session 603 is hosted, over one or more network(s) 608, by the system 602. That is, the system 602 can provide a service that enables users of the client computing devices 606(1) through 606(N) to participate in the communication session 603 (e.g., via a live viewing and/or a recorded viewing). Consequently, a “participant” to the communication session 603 can comprise a user and/or a client computing device (e.g., multiple users may be in a room participating in a communication session via the use of a single client computing device), each of which can communicate with other participants. As an alternative, the communication session 603 can be hosted by one of the client computing devices 606(1) through 606(N) utilizing peer-to-peer technologies. The system 602 can also host chat conversations and other team collaboration functionality (e.g., as part of an application suite).

In some implementations, such chat conversations and other team collaboration functionality are considered external communication sessions distinct from the communication session 603. A computing system 602 that collects participant data in the communication session 603 may be able to link to such external communication sessions. Therefore, the system may receive information, such as date, time, session particulars, and the like, that enables connectivity to such external communication sessions. In one example, a chat conversation can be conducted in accordance with the communication session 603. Additionally, the system 602 may host the communication session 603, which includes at least a plurality of participants co-located at a meeting location, such as a meeting room or auditorium, or located in disparate locations.

In examples described herein, client computing devices 606(1) through 606(N) participating in the communication session 603 are configured to receive and render for display, on a user interface of a display screen, communication data. The communication data can comprise a collection of various instances, or streams, of live content and/or recorded content. The collection of various instances, or streams, of live content and/or recorded content may be provided by one or more cameras, such as video cameras. For example, an individual stream of live or recorded content can comprise media data associated with a video feed provided by a video camera (e.g., audio and visual data that capture the appearance and speech of a user participating in the communication session). In some implementations, the video feeds may comprise such audio and visual data, one or more still images, and/or one or more avatars. The one or more still images may also comprise one or more avatars.

Another example of an individual stream of live or recorded content can comprise media data that includes an avatar of a user participating in the communication session along with audio data that captures the speech of the user. Yet another example of an individual stream of live or recorded content can comprise media data that includes a file displayed on a display screen along with audio data that captures the speech of a user. Accordingly, the various streams of live or recorded content within the communication data enable a remote meeting to be facilitated between a group of people and the sharing of content within the group of people. In some implementations, the various streams of live or recorded content within the communication data may originate from a plurality of co-located video cameras, positioned in a space, such as a room, to record or stream live a presentation that includes one or more individuals presenting and one or more individuals consuming presented content.

A participant or attendee can view content of the communication session 603 live as activity occurs, or alternatively, via a recording at a later time after the activity occurs. In the examples described herein, client computing devices 606(1) through 606(N) participating in the communication session 603 are configured to receive and render for display, on a user interface of a display screen, communication data. The communication data can comprise a collection of various instances, or streams, of live and/or recorded content. For example, an individual stream of content can comprise media data associated with a video feed (e.g., audio and visual data that capture the appearance and speech of a user participating in the communication session). Another example of an individual stream of content can comprise media data that includes an avatar of a user participating in the conference session along with audio data that captures the speech of the user. Yet another example of an individual stream of content can comprise media data that includes a content item displayed on a display screen and/or audio data that captures the speech of a user. Accordingly, the various streams of content within the communication data enable a meeting or a broadcast presentation to be facilitated amongst a group of people dispersed across remote locations.

A participant or attendee to a communication session is a person that is in range of a camera, or other image and/or audio capture device such that actions and/or sounds of the person which are produced while the person is viewing and/or listening to the content being shared via the communication session can be captured (e.g., recorded). For instance, a participant may be sitting in a crowd viewing the shared content live at a broadcast location where a stage presentation occurs. Or a participant may be sitting in an office conference room viewing the shared content of a communication session with other colleagues via a display screen. Even further, a participant may be sitting or standing in front of a personal device (e.g., tablet, smartphone, computer, etc.) viewing the shared content of a communication session alone in their office or at home.

The system 602 of FIG. 10 includes device(s) 610. The device(s) 610 and/or other components of the system 602 can include distributed computing resources that communicate with one another and/or with the client computing devices 606(1) through 606(N) via the one or more network(s) 608. In some examples, the system 602 may be an independent system that is tasked with managing aspects of one or more communication sessions such as communication session 603. As an example, the system 602 may be managed by entities such as SLACK, WEBEX, GOTOMEETING, GOOGLE HANGOUTS, etc.

Network(s) 608 may include, for example, public networks such as the Internet, private networks such as an institutional and/or personal intranet, or some combination of private and public networks. Network(s) 608 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 608 may utilize communications protocols, including packet-based and/or datagram-based protocols such as Internet protocol (“IP”), transmission control protocol (“TCP”), user datagram protocol (“UDP”), or other types of protocols. Moreover, network(s) 608 may also include a number of devices that facilitate network communications and/or form a hardware basis for the networks, such as switches, routers, gateways, access points, firewalls, base stations, repeaters, backbone devices, and the like.

In some examples, network(s) 608 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, 802.11ac and so forth), and other standards.

In various examples, device(s) 610 may include one or more computing devices that operate in a cluster or other grouped configuration to share resources, balance load, increase performance, provide fail-over support or redundancy, or for other purposes. For instance, device(s) 610 may belong to a variety of classes of devices such as traditional server-type devices, desktop computer-type devices, and/or mobile-type devices. Thus, although illustrated as a single type of device or a server-type device, device(s) 610 may include a diverse variety of device types and are not limited to a particular type of device. Device(s) 610 may represent, but are not limited to, server computers, desktop computers, web-server computers, personal computers, mobile computers, laptop computers, tablet computers, or any other sort of computing device.

A client computing device (e.g., one of client computing device(s) 606(1) through 606(N)) (each of which are also referred to herein as a “data processing system”) may belong to a variety of classes of devices, which may be the same as, or different from, device(s) 610, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (“AR”) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 606(1) through 606(N) of the various classes and device types can represent any type of computing device having one or more data processing unit(s) 692 operably connected to computer-readable media 694 such as via a bus 616, which in some instances can include one or more of a system bus, a data bus, an address bus, a PCI bus, a Mini-PCI bus, and any variety of local, peripheral, and/or independent buses.

Executable instructions stored on computer-readable media 694 may include, for example, an operating system 619, a client module 620, a profile module 622, and other modules, programs, or applications that are loadable and executable by data processing units(s) 692.

Client computing device(s) 606(1) through 606(N) may also include one or more interface(s) 624 to enable communications between client computing device(s) 606(1) through 606(N) and other networked devices, such as device(s) 610, over network(s) 608. Such network interface(s) 624 may include one or more network interface controllers (NICs) or other types of transceiver devices to send and receive communications and/or data over a network. Moreover, client computing device(s) 606(1) through 606(N) can include input/output (“I/O”) interfaces (devices) 626 that enable communications with input/output devices such as user input devices including peripheral input devices (e.g., a game controller, a keyboard, a mouse, a pen, a voice input device such as a microphone, a video camera for obtaining and providing video feeds and/or still images, a touch input device, a gestural input device, and the like) and/or output devices including peripheral output devices (e.g., a display, a printer, audio speakers, a haptic output device, and the like). FIG. 10 illustrates that client computing device 606(1) is in some way connected to a display device (e.g., a display screen 629(N)), which can display a UI according to the techniques described herein.

In the example environment 600 of FIG. 10, client computing devices 606(1) through 606(N) may use their respective client modules 620 to connect with one another and/or other external device(s) in order to participate in the communication session 603, or in order to contribute activity to a collaboration environment. For instance, a first user may utilize a client computing device 606(1) to communicate with a second user of another client computing device 606(2). When executing client modules 620, the users may share data, which may cause the client computing device 606(1) to connect to the system 602 and/or the other client computing devices 606(2) through 606(N) over the network(s) 608.

The client computing device(s) 606(1) through 606(N) may use their respective profile modules 622 to generate participant profiles (not shown in FIG. 10) and provide the participant profiles to other client computing devices and/or to the device(s) 610 of the system 602. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for communication sessions.

As shown in FIG. 10, the device(s) 610 of the system 602 include a server module 630 and an output module 632. In this example, the server module 630 is configured to receive, from individual client computing devices such as client computing devices 606(1) through 606(N), media streams 634(1) through 634(N). As described above, media streams can comprise a video feed (e.g., audio and visual data associated with a user), audio data which is to be output with a presentation of an avatar of a user (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 630 is configured to receive a collection of various media streams 634(1) through 634(N) during a live viewing of the communication session 603 (the collection being referred to herein as “media data 634”). In some scenarios, not all of the client computing devices that participate in the communication session 603 provide a media stream. For example, a client computing device may only be a consuming, or a “listening”, device such that it only receives content associated with the communication session 603 but does not provide any content to the communication session 603.

In various examples, the server module 630 can select aspects of the media streams 634 that are to be shared with individual ones of the participating client computing devices 606(1) through 606(N). Consequently, the server module 630 may be configured to generate session data 636 based on the streams 634 and/or pass the session data 636 to the output module 632. Then, the output module 632 may transmit communication data 639 to the client computing devices (e.g., client computing devices 606(1) through 606(3) participating in a live viewing of the communication session). The communication data 639 may include video, audio, and/or other content data, provided by the output module 632 based on content 650 associated with the output module 632 and based on received session data 636. The content 650 can include the streams 634 or other shared data, such as an image file, a spreadsheet file, a slide deck, a document, etc. The streams 634 can include a video component depicting images captured by an I/O device 626 on each client computer.

As shown, the output module 632 transmits communication data 639(1) to client computing device 606(1), and transmits communication data 639(2) to client computing device 606(2), and transmits communication data 639(3) to client computing device 606(3), etc. The communication data 639 transmitted to the client computing devices can be the same or can be different (e.g., positioning of streams of content within a user interface may vary from one device to the next).

In various implementations, the device(s) 610 and/or the client module 620 can include GUI presentation module 640. The GUI presentation module 640 may be configured to analyze communication data 639 that is for delivery to one or more of the client computing devices 606. Specifically, the UI presentation module 640, at the device(s) 610 and/or the client computing device 606, may analyze communication data 639 to determine an appropriate manner for displaying video, image, and/or content on the display screen 629 of an associated client computing device 606. In some implementations, the GUI presentation module 640 may provide video, image, and/or content to a presentation GUI 646 rendered on the display screen 629 of the associated client computing device 606. The presentation GUI 646 may be caused to be rendered on the display screen 629 by the GUI presentation module 640. The presentation GUI 646 may include the video, image, and/or content analyzed by the GUI presentation module 640.

In some implementations, the presentation GUI 646 may include a plurality of sections or grids that may render or comprise video, image, and/or content for display on the display screen 629. For example, a first section of the presentation GUI 646 may include a video feed of a presenter or individual, a second section of the presentation GUI 646 may include a video feed of an individual consuming meeting information provided by the presenter or individual. The GUI presentation module 640 may populate the first and second sections of the presentation GUI 646 in a manner that properly imitates an environment experience that the presenter and the individual may be sharing.

In some implementations, the GUI presentation module 640 may enlarge or provide a zoomed view of the individual represented by the video feed in order to highlight a reaction, such as a facial feature, the individual had to the presenter. In some implementations, the presentation GUI 646 may include a video feed of a plurality of participants associated with a meeting, such as a general communication session. In other implementations, the presentation GUI 646 may be associated with a channel, such as a chat channel, enterprise Teams channel, or the like. Therefore, the presentation GUI 646 may be associated with an external communication session that is different from the general communication session.

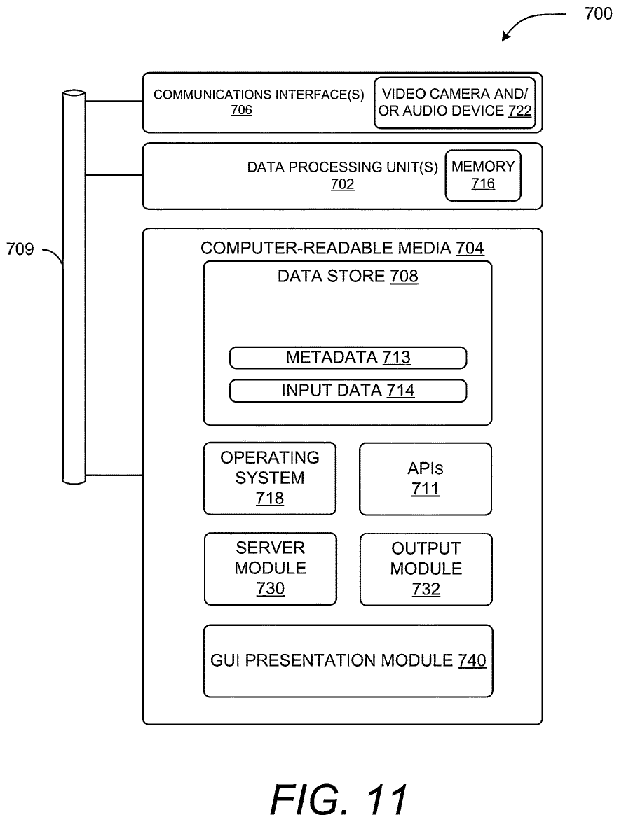

FIG. 11 illustrates a diagram that shows example components of an example device 700 (also referred to herein as a “computing device”) configured to generate data for some of the user interfaces disclosed herein. The device 700 may generate data that may include one or more sections that may render or comprise video, images, virtual objects, and/or content for display on the display screen 629. The device 700 may represent one of the device(s) described herein. The device 700 may represent one of any of the devices disclosed herein, e.g., device 606 of FIG. 10, device 11 of FIG. 1, or a server 602 of FIG. 10.

As illustrated, the device 700 includes one or more data processing unit(s) 702, computer-readable media 704, and communication interface(s) 706. The components of the device 700 are operatively connected, for example, via a bus 709, which may include one or more of a system bus, a data bus, an address bus, a PCI bus, a Mini-PCI bus, and any variety of local, peripheral, and/or independent buses.

As utilized herein, data processing unit(s), such as the data processing unit(s) 702 and/or data processing unit(s) 692, may represent, for example, a CPU-type data processing unit, a GPU-type data processing unit, a field-programmable gate array (“FPGA”), another class of DSP, or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 704 and computer-readable media 694, may store instructions executable by the data processing unit(s). The computer-readable media may also store instructions executable by external data processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media, which might also be referred to herein as a computer-readable medium, may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device. The computer storage media can also be referred to herein as computer-readable storage media, non-transitory computer-readable storage media, non-transitory computer-readable medium, or computer storage medium.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se. In one example, the computer storage media can be block 704 in FIG. 11 or block 694 in FIG. 10.

Communication interface(s) 706 may represent, for example, network interface controllers (“NICs”) or other types of transceiver devices to send and receive communications over a network. Furthermore, the communication interface(s) 706 may include one or more video cameras and/or audio devices 722 to enable generation of video feeds and/or still images, and so forth.

In the illustrated example, computer-readable media 704, which can also be storage media, includes a data store 708. In some examples, the data store 708 includes data storage such as a database, data warehouse, or other type of structured or unstructured data storage. In some examples, the data store 708 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 708 may store data for the operations of processes, applications, components, and/or modules stored in computer-readable media 704 and/or executed by data processing unit(s) 702 and/or accelerator(s). For instance, in some examples, the data store 708 may store session data (e.g., session data 636 as shown in FIG. 7), metadata 713 (e.g., the data structure shown and described herein), and/or other data such as input data 714, which can include voice commands, a mouse input, a touch input, or other definitions of input gestures. The session data can include a total number of participants (e.g., users and/or client computing devices) in a communication session, activity that occurs in the communication session, a list of invitees to the communication session, and/or other data related to when and how the communication session is conducted or hosted. The data store 708 may also include contextual data, such as the content that includes video, audio, or other content for rendering and display on one or more of the display screens 629. Hardware data 711 can define aspects of any device, such as a number of display screens of a computer. The contextual data can define any type of activity or status related to the individual users 10A-10F each associated with individual video streams of a plurality of video streams 634. For instance, the contextual data can define a person's level in an organization, how each person's level relates to the level of others, a performance level of a person, or any other activity or status information that can be used to determine a position for a rendering of a person within a virtual environment.

Alternately, some or all of the above-referenced data can be stored on separate memories 716 on board one or more data processing unit(s) 702 such as a memory on board a CPU-type processor, a GPU-type processor, an FPGA-type accelerator, a DSP-type accelerator, and/or another accelerator. In this example, the computer-readable media 704 also includes an operating system 718 and application programming interface(s) (APIs) configured to expose the functionality and the data of the device 700 to other devices. Additionally, the computer-readable media 704 includes one or more modules such as the server module 730, the output module 732, and the GUI presentation module 740, although the number of illustrated modules is just an example, and the number may vary. That is, functionality described herein in association with the illustrated modules may be performed by a fewer number of modules or a larger number of modules on one device or spread across multiple devices.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for managing access permissions to messages threads of a communication system, the method comprising:
causing a display of an original user interface comprising an original thread of a plurality of messages, wherein permission data allows a first computing device of a first user and a second computing device of a second user to display an original message of the plurality of messages of the original thread;
receiving an input for invoking a split of the original thread to create a first new thread associated with a first topic and a second new thread associated with a second topic, wherein the split of the original thread causes a split of the text content of the original message into a first text portion of the original message and a second text portion of the original message;
responsive to the input for invoking instructions to split the original thread, causing the original user interface to split the original thread by displaying a first message within the first new thread associated with the first topic and displaying a second message in the second new thread associated with the second topic, wherein the first message comprises the first text portion split from the original message, and wherein the second message comprises the second text portion split from the original message;
responsive to an input causing an addition of a third user to the second new thread, modifying the permission data to allow a third computing device of the third user to display messages associated with the second new thread, wherein the permission data restricts the third computing device of the third user from displaying messages associated with the original thread and the first new thread; and
causing a display of a new user interface on the third computing device of the third user, the new user interface comprising the messages associated with the second new thread, wherein the permission data restricts the third computing device of the third user from displaying the messages associated with the original thread and the first new thread.

2. The method of claim 1, wherein the permission data is stored in association with thread family data that defines the relationships between the original thread and the first new thread and the second new thread.

3. (canceled)

4. (canceled)

5. The method of claim 1, wherein the permission data is configured to permit the third computing device of the third user to access a set of messages of the second new thread that meet one or more criteria, wherein the set of messages of the second new thread are provided to the second new thread prior to the addition of the third user, wherein the one or more criteria is used to select the set of messages of the second new thread is based on a time threshold from a time the third user was added to the second new thread or a predetermined number of messages sent prior to the addition of the third user, wherein the one or more criteria is provided by an input of the first user or the second user.

6. The method of claim 1, wherein the method further comprises:
receiving an indication causing a removal of the third user from the second new thread; and
responsive to the indication causing the removal of the third user from the second new thread, updating the permission data to restrict the third computing device associated with the third user from accessing the messages of the second new thread while maintaining the restriction of the original thread and the first new thread.

7. The method of claim 1, wherein the method further comprises:
receiving an indication causing a removal of the third user from the second new thread; and
responsive to the indication causing the removal of the third user from the second new thread, updating the permission data to restrict the third computing device associated with the third user from accessing the messages of the second new thread while maintaining the restriction of the first new thread and allowing access to a set of messages of the original thread, wherein the set of messages of the original thread is defined by a policy established by at least one of the first user or the second user.

8. The method of claim 1, wherein the method further comprises:
receiving an indication causing a removal of the second user from the second new thread; and
responsive to the indication causing the removal of the second user from the second new thread, updating the permission data to restrict the second computing device associated with the second user from accessing the messages of the second new thread while maintaining access to the first new thread.

9. A computing device for managing access permissions for messages threads, comprising:
one or more processing units; and
a computer-readable storage medium having encoded thereon computer-executable instructions to cause the one or more processing units to:
cause a display of a first user interface comprising an original thread of a plurality of messages, wherein permission data allows a first computing device of a first user and a second computing device of a second user to display an original message of the plurality of messages of the original thread;
receive an input for invoking a split of the original thread to create a first new thread associated with a first topic and a second new thread associated with a second topic, wherein the split of the original thread causes a split of the text content of the original message into a first text portion of the original message and a second text portion of the original message;
responsive to the input for invoking instructions to split the original thread, cause the first user interface to split the original thread by displaying a first message within the first new thread associated with the first topic and displaying a second message in the second new thread associated with the second topic, wherein the first message comprises the first text portion split from the original message, and wherein the second message comprises the second text portion split from the original message;
responsive to an input causing an addition of a third user to the second new thread, modify the permission data to allow a third computing device of the third user to display messages associated with the second new thread, wherein the permission data restricts the third computing device of the third user from displaying messages associated with the original thread and the first new thread; and
cause a display of a new user interface on the third computing device of the third user, the new user interface comprising the messages associated with the second new thread, wherein the permission data restricts the third computing device of the third user from displaying the messages associated with the original thread and the first new thread.

10. The computing device of claim 9, wherein the permission data is stored in association with thread family data that defines the relationships between the original thread and the first new thread and the second new thread.

11. The computing device of claim 9, wherein the permission data is configured to restrict the third computing device from receiving messages stored in a thread container of the original thread and the first new thread.

12. The computing device of claim 9, wherein the permission data is configured to permit the third computing device of the third user to access a set of messages of the second new thread that meet one or more criteria, wherein the set of messages of the second new thread are provided to the second new thread prior to the addition of the third user.

13. The computing device of claim 12, wherein the one or more criteria is used by the computing device to select the set of messages of the second new thread is based on a time threshold from a time the third user was added to the second new thread or a predetermined number of messages sent prior to the addition of the third user, wherein the one or more criteria is provided by an input of the first user or the second user.

14. The computing device of claim 9, wherein the computer-executable instructions further cause the one or more processing units to:
receive an indication causing a removal of the third user from the second new thread; and
responsive to the indication causing the removal of the third user from the second new thread, update the permission data to restrict the third computing device associated with the third user from accessing the messages of the second new thread while maintaining the restriction of the original thread and the first new thread.

15. The computing device of claim 9, wherein the computer-executable instructions further cause the one or more processing units to:
receive an indication causing a removal of the third user from the second new thread; and
responsive to the indication causing the removal of the third user from the second new thread, update the permission data to restrict the third computing device associated with the third user from accessing the messages of the second new thread while maintaining the restriction of the first new thread and allowing access to a set of messages of the original thread, wherein the set of messages of the original thread is defined by a policy established by at least one of the first user or the second user.

16. One or more computer storage media having encoded thereon computer-executable instructions to cause one or more processing units of a system to:
cause a display of a first user interface comprising an original thread of a plurality of messages, wherein permission data allows a first computing device of a first user and a second computing device of a second user to display an original message of the plurality of messages of the original thread;
receive an input for invoking a split of the original thread to create a first new thread associated with a first topic and a second new thread associated with a second topic, wherein the split of the original thread causes a split of the text content of the original message into a first text portion of the original message and a second text portion of the original message;
responsive to the input for invoking instructions to split the original thread, cause the first user interface to split the original thread by displaying a first message within the first new thread associated with the first topic and displaying a second message in the second new thread associated with the second topic, wherein the first message comprises the first text portion split from the original message, and wherein the second message comprises the second text portion split from the original message;
responsive to an input causing an addition of a third user to the second new thread, modify the permission data to allow a third computing device of the third user to display messages associated with the second new thread, wherein the permission data restricts the third computing device of the third user from displaying messages associated with the original thread and the first new thread; and
cause a display of a new user interface on the third computing device of the third user, the new user interface comprising the messages associated with the second new thread, wherein the permission data restricts the third computing device of the third user from displaying the messages associated with the original thread and the first new thread.

17. The one or more computer storage media of claim 16, wherein the permission data is stored in association with thread family data that defines the relationships between the original thread and the first new thread and the second new thread.

18. (canceled)

19. The one or more computer storage media of claim 16, wherein the permission data is configured to permit the third computing device of the third user to access a set of messages of the second new thread that meet one or more criteria, wherein the set of messages of the second new thread are provided to the second new thread prior to the addition of the third user.

20. The one or more computer storage media of claim 16, wherein the one or more criteria is used by the computing device to select the set of messages of the second new thread is based on a time threshold from a time the third user was added to the second new thread or a predetermined number of messages sent prior to the addition of the third user, wherein the one or more criteria is provided by an input of the first user or the second user.

21. The method of claim 1, further comprising: analyzing the text content of the original message for the purposes of splitting the original message into separate messages to be assigned to two separate threads.

22. The method of claim 1, further comprising: analyzing the text content of the original message for the purposes of splitting the original message into separate messages to be assigned to two separate threads, wherein the analysis of the text content of the original message is in response to identifying one or more attributes of the original message.

23. The method of claim 1, further comprising: analyzing the text content of the original message for the purposes of splitting the original message into separate messages to be assigned to two separate threads, wherein the analysis of the text content of the original message is in response to identifying one or more predetermined attributes of the original message, wherein the analysis identifies the first topic and the second topic in the original message, wherein the one or more predetermined attributes include a time associated with the message, a position of the original message within a user interface, predetermined content of the original message, or a format of the original message.
